(19) United States
(12) Patent Application Publication
(10) Pub. No.: US 2024/0253423 A1
(43) Pub. Date: Aug. 1, 2024

(54) VEHICULAR HEAT MANAGEMENT SYSTEM

(71) Applicant: HANON SYSTEMS, Daejeon (KR)

(72) Inventors: Jun Min LEE, Daejeon (KR); Young In KIM, Daejeon (KR); Yong Sik KIM, Daejeon (KR); Hyeon Gyu KIM, Daejeon (KR); Chan Young LEE, Daejeon (KR)

(21) Appl. No.: 18/277,467

(22) PCT Filed: Oct. 5, 2022
(86) PCT No.: PCT/KR2022/014933

§ 371 Date: Aug. 16, 2023

(30) Foreign Application Priority Data
Oct. 21, 2021 (KR) 10-2021-0141178

(51) Int. Cl. B60H 1/32; B60H 1/00

(52) U.S. Cl. CPC B60H 1/3205; B60H 1/00735; B60H 1/00899

(57) ABSTRACT

A vehicular heat management system includes: a refrigerant circulation line including a compressor, a high pressure side heat exchanger, an outdoor heat exchanger, a plurality of expansion valves arranged on the heat pump type refrigerant circulation line, and a low pressure side heat exchanger; and a control part configured to calculate an optimal control value by arithmetically processing real-time information on one or more factors affecting a temperature and a pressure of a refrigerant circulating along the refrigerant circulation line, through the use of a pre-stored calculation formula, and control at least one of the expansion valves based on the calculated optimal control value.

### TECHNICAL FIELD

The present invention relates to a vehicular heat management system and, more particularly, to a vehicular heat management system configured to optimally control the opening degree of a heat pump mode expansion valve regardless of the overheating degree of a refrigerant on the outlet side of an outdoor heat exchanger and capable of preventing a decrease in control precision of the heat pump mode expansion valve caused by the control based on the overheating degree of a refrigerant on the outlet side of an outdoor heat exchanger and a resultant decrease in heating performance for the vehicle interior.

### BACKGROUND ART

Examples of an eco-friendly vehicle include an electric vehicle, a hybrid vehicle, and a fuel cell vehicle (hereinafter collectively referred to as “vehicle”).

Such a vehicle is equipped with an air conditioning system 10 for cooling and heating air conditioning regions as shown in FIG. 1.

The air conditioning system 10 is of a heat pump type and is provided with a refrigerant circulation line 12.

The refrigerant circulation line 12 includes a compressor 12a, a high pressure side heat exchanger 12b, a heat pump mode expansion valve 12c, an outdoor heat exchanger 12d, a plurality of air conditioner mode expansion valves 12e installed in parallel with each other, and a plurality of low pressure side heat exchangers 12f installed downstream of the respective air conditioner mode expansion valves 12e.

In the refrigerant circulation line 12, in an air conditioner mode, the heat pump mode expansion valve 12c is completely opened, so that the refrigerant in the compressor 12a is not depressurized and expanded by the heat pump mode expansion valve 12c and is circulated in the order of the high pressure side heat exchanger 12b, the outdoor heat exchanger 12d, the air conditioner mode expansion valve 12e and the low pressure side heat exchanger 12f.

Low-temperature cold air is generated in the low pressure side heat exchangers 12f through the circulation of the refrigerant, and the generated cold air is transferred to air-conditioning regions of the vehicle, for example, a vehicle interior and a battery 20. Thus, the vehicle interior and the battery 20 are cooled.

In addition, in a heat pump mode, the heat pump mode expansion valve 12c is turned on to allow the refrigerant to be depressurized and expanded, so that the refrigerant in the compressor 12a can circulate in the order of the high pressure side heat exchanger 12b, the heat pump mode expansion valve 12c and the outdoor heat exchanger 12d.

High-temperature heat is generated in the high pressure side heat exchanger 12b through the circulation of the refrigerant, and the generated heat is supplied to the vehicle interior to heat the vehicle interior.

In this regard, the heat pump mode expansion valve 12c is an electronic expansion valve EXV, and is configured such that the opening degree thereof varies according to the overheating degree of the refrigerant on the outlet side of the outdoor heat exchanger 12d in the heat pump mode.

In particular, the heat pump mode expansion valve 12c is configured so that the opening degree thereof varies according to the overheating degree of the refrigerant calculated based on the refrigerant pressure and temperature of the first PT sensor 30 installed on the outlet side of the outdoor heat exchanger 12d.

Therefore, the amount of refrigerant introduced into the outdoor heat exchanger 12d is automatically adjusted in response to the heat load of the outdoor heat exchanger 12d, and consequently the heating performance of the high pressure side heat exchanger 12b is automatically adjusted according to the heat load of the outdoor heat exchanger 12d.

However, in the conventional air conditioning system 10, when the overheating degree of the refrigerant is calculated based on the pressure and temperature of the refrigerant on the outlet side of the outdoor heat exchanger 12d, the value of the calculated overheating degree is too small. This makes it difficult to optimally control the heat pump mode expansion valve 12c.

In particular, when the opening degree of the heat pump mode expansion valve 12c is changed, the overheating degree of the refrigerant on the outlet side of the outdoor heat exchanger 12d is also changed. At this time, the overheating degree and sensitivity of the refrigerant on the outlet side of the outdoor heat exchanger 12d calculated according to the change amount of the opening degree of the heat pump mode expansion valve 12c are too small.

Therefore, the change in the opening degree of the heat pump mode expansion valve 12c is not properly reflected in the control of the heat pump mode expansion valve 12c.

Thus, the sensitivity and responsiveness of the heat pump mode expansion valve 12c deteriorate. This makes it impossible to precisely respond to a small change in the opening degree of the heat pump mode expansion valve 12c. As a result, the control precision for the heat pump mode expansion valve 12c is lowered, and the heating performance in the vehicle interior is reduced.

### SUMMARY

In view of the problems inherent in the related art, it is an object of the present invention to provide a vehicular heat management system capable of improving the control logic of a heat pump mode expansion valve to optimally control the opening degree of the heat pump mode expansion valve regardless of the overheating degree of a refrigerant on the outlet side of an outdoor heat exchanger.

Another object of the present invention is to provide a vehicular heat management system capable of preventing a decrease in control precision of the heat pump mode expansion valve caused by the control based on the overheating degree of a refrigerant on the outlet side of an outdoor heat exchanger and a resultant decrease in heating performance for the vehicle interior.

A further object of the present invention is to provide a vehicular heat management system capable of improving the control logic of a heat pump mode expansion valve to reflect a small change in the opening degree of a heat pump mode expansion valve in the control of the heat pump mode expansion valve and to improve the control precision, sensitivity, and responsiveness of the heat pump mode expansion valve.

A still further object of the present invention is to provide a vehicular heat management system capable of improving the heating performance for the vehicle interior by improving the control precision, sensitivity, and responsiveness of the heat pump mode expansion valve.

In order to achieve these objects, there is provided a vehicular heat management system, including: a refrigerant circulation line including a compressor, a high pressure side heat exchanger, an outdoor heat exchanger, a plurality of expansion valves arranged on the heat pump type refrigerant circulation line, and a low pressure side heat exchanger; and a control part configured to calculate an optimal control value by arithmetically processing real-time information on one or more factors affecting a temperature and a pressure of a refrigerant circulating along the refrigerant circulation line, through the use of a pre-stored calculation formula, and control at least one of the expansion valves based on the calculated optimal control value.

The factors affecting the temperature and the pressure of the refrigerant may include a compressor rotational speed (rpm), an outside air temperature, an outdoor heat exchanger air flow rate, and a recirculated inside air temperature, and the control part may be configured to calculate the optimal control value by arithmetically processing information on the compressor rpm, the outside air temperature, the outdoor heat exchanger air flow rate, and the recirculated inside air temperature, through the use of the pre-stored calculation formula, and control at least one of the expansion valves based on the calculated optimal control value.

The expansion valves may include a heat pump mode expansion valve configured to depressurize and expand a refrigerant flowing from the high pressure side heat exchanger to the outdoor heat exchanger in a heat pump mode, and the control part may be configured to control an opening degree of the heat pump mode expansion valve based on the calculated optimal control value in the heat pump mode.

The control part may be configured to calculate an optimal control value for the heat pump mode expansion valve as a refrigerant compression ratio (X) by arithmetically processing the information on the compressor rpm, the outside air temperature, the outdoor heat exchanger air flow rate, and the recirculated inside air temperature, which are inputted in real time from individual sensors, through the use of the following calculation formula (1): refrigerant compression ratio (X)=A×compressor rpm+B×outside air temperature+C×outdoor heat exchanger air flow rate+D×recirculated inside air temperature×E, where A is a correction coefficient for compressor rpm, B is a correction coefficient for outside air temperature, C is a correction coefficient for outdoor heat exchanger air flow rate, D is a correction coefficient for recirculated inside air temperature, and E is an experimental value constant.

The control part may be configured to compare the refrigerant compression ratio (X) calculated through the use of the calculation formula (1) with a current refrigerant compression ratio (K) calculated through the use of detection data of individual PT sensors on the refrigerant circulation line, and variably control the opening degree of the heat pump mode expansion valve based on the result of comparison.

The control part may be configured to calculate an optimal control value for the heat pump mode expansion valve as a refrigerant overcooling degree (Y) by arithmetically processing the information on the compressor rpm, the outside air temperature, the outdoor heat exchanger air flow rate, and the recirculated inside air temperature, which are inputted in real time from individual sensors, through the use of the following calculation formula (2): refrigerant overcooling degree (Y)=a×compressor rpm+b×outside air temperature+c×outdoor heat exchanger air flow rate+d×recirculated inside air temperature×e, where a is a correction coefficient for compressor rpm, b is a correction coefficient for outside air temperature, c is a correction coefficient for outdoor heat exchanger air flow rate, d is a correction coefficient for recirculated inside air temperature, and e is an experimental value constant.

The control part may be configured to compare the optimal refrigerant overcooling degree (Y) calculated through the use of the calculation formula (2) with a current refrigerant overcooling degree (L) calculated through the use of detection data of individual PT sensors on the refrigerant circulation line, and variably control the opening degree of the heat pump mode expansion valve based on the result of comparison.

The control part may be configured to variably control the rotational speed of the compressor according to a discharge air temperature in a vehicle interior changed in real time in a process of controlling the expansion valve and a target discharge temperature.

According to the vehicular heat management system of the present invention, factors affecting the temperature and pressure of a refrigerant are arithmetically processed using a pre-stored calculation formula to calculate an optimal control value, and the opening degree of the heat pump mode expansion valve is controlled based on the calculated optimal control value. Therefore, unlike the conventional system in which the heat pump mode expansion valve is controlled based on the overheating degree of the refrigerant on the outlet side of the outdoor heat exchanger which has low sensitivity, it is possible to optimally control the opening degree of the heat pump mode expansion valve.

In addition, since the opening degree of the heat pump mode expansion valve is controlled with the optimal control value calculated by the pre-stored calculation formula, it is possible to optimally control the opening degree of the heat pump mode expansion valve regardless of the overheating degree of the refrigerant.

In addition, since the opening degree of the heat pump mode expansion valve can be optimally controlled regardless of the overheating degree of the refrigerant, it is possible to prevent a decrease in control precision of the heat pump mode expansion valve caused by the control based on the overheating degree of the refrigerant and a resultant decrease in heating performance for the vehicle interior.

In addition, since the optimal control value for the heat pump mode expansion valve is calculated based on all factors affecting the pressure and temperature of the refrigerant, a small change in the opening degree of the heat pump mode expansion valve can be precisely reflected in the control of the heat pump mode expansion valve.

In addition, since the small change in the opening degree of the heat pump mode expansion valve can be precisely reflected in the control of the heat pump mode expansion valve, it is possible to improve the control precision, sensitivity, and responsiveness of the heat pump mode expansion valve.

In addition, since the control precision, sensitivity, and responsiveness of the heat pump mode expansion valve can be improved, it is possible to improve the heating performance in the vehicle interior.

### BRIEF DESCRIPTION OF THE DRAWINGS

FIG. 1 is a diagram showing a conventional vehicular heat management system.

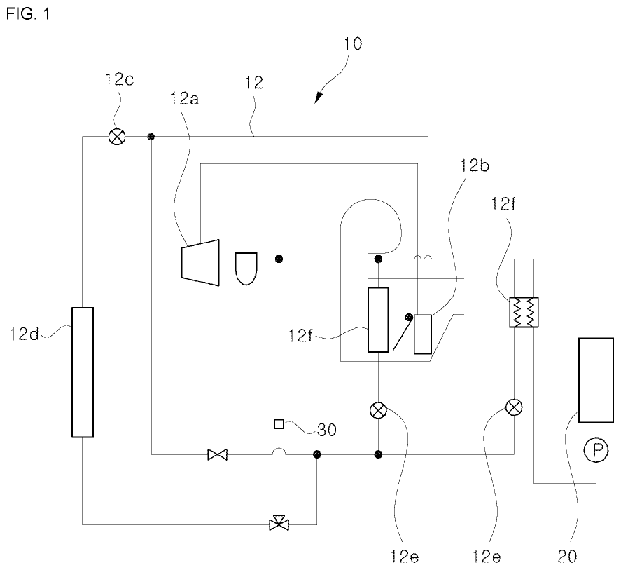

FIG. 2 is a view showing the configuration of a vehicular heat management system according to the present invention.

FIG. 3 is a flowchart showing an operation example of the vehicular heat management system according to a first embodiment of the present invention.

FIG. 4 is a flowchart showing an operation example of the vehicular heat management system according to a second embodiment of the present invention.

FIG. 5 is a flowchart showing an operation example of the vehicular heat management system according to a third embodiment of the present invention.

### DETAILED DESCRIPTION

Preferred embodiments of a vehicular heat management system according to the present invention will now be described in detail with reference to the accompanying drawings.

### First Embodiment

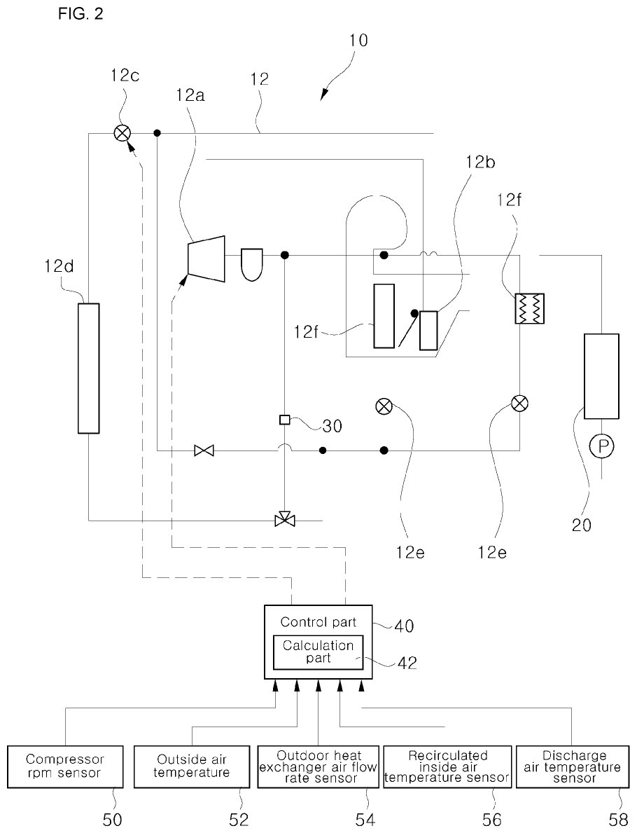

Prior to describing the features of the vehicular heat management system according to the present invention, the general configurations of the vehicular heat management system will be briefly described with reference to FIG. 2.

The vehicular heat management system is provided with an air conditioning system 10 for cooling and heating air conditioning regions.

The air conditioning system 10 is of a heat pump type and is provided with a refrigerant circulation line 12. The refrigerant circulation line 12 includes a compressor 12a, a high pressure side heat exchanger 12b, a heat pump mode expansion valve 12c, an outdoor heat exchanger 12d, a plurality of air conditioner mode expansion valves 12e installed in parallel with each other, and a plurality of low pressure side heat exchangers 12f installed downstream of the respective air conditioner mode expansion valves 12e.

In the refrigerant circulation line 12, in an air conditioner mode, the heat pump mode expansion valve 12c is completely opened to limit the depressurization and expansion of a refrigerant, thereby generating a low-temperature cold air in the low pressure side heat exchangers 12f. The cold air thus generated is transferred to air conditioning regions of the vehicle, for example, a vehicle interior and a battery 20, to cool the vehicle interior and the battery 20.

In addition, in a heat pump mode, the heat pump mode expansion valve 12c is turned on to allow the refrigerant to be depressurized and expanded, so that high-temperature heat is generated in the high pressure side heat exchanger 12b. The heat thus generated is supplied to the vehicle interior to heat the vehicle interior.

Next, features of the vehicular heat management system according to the present invention will be described in detail with reference to FIG. 2.

The vehicular heat management system according to the present invention includes a control part 40.

The control part 40, which is equipped with a microprocessor, includes a calculation part 42 configured to calculate an optimal control value based on real-time information on one or more factors affecting the temperature and pressure of the refrigerant circulating along the refrigerant circulation line 12.

The calculation part 42, as a kind of arithmetic operation program, is configured to calculate an optimal control value for controlling the heat pump mode expansion valve 12c by arithmetically processing various factors affecting the temperature and pressure of the refrigerant, for example, the rotational speed (rpm) of the compressor 12a, the outside air temperature, the flow rate of the air passing through the outdoor heat exchanger 12d, and the temperature of the air in the vehicle interior recirculated into the air conditioning system, through the use of a pre-stored calculation formula.

More specifically, the temperature and pressure of the refrigerant circulating along the refrigerant circulation line 12 are determined by the above-mentioned factors, i.e., the rotational speed of the compressor 12a, the outside air temperature, the flow rate of the air passing through the outdoor heat exchanger 12d, and the temperature of the air in the vehicle interior recirculated into the air conditioning system.

At this time, the calculation part 42 calculate an optimal control value for controlling the heat pump mode expansion valve 12c by arithmetically processing the compressor RPM information, the outside air temperature information, the outdoor heat exchanger air flow rate information, the recirculated inside air temperature information, and the like inputted in real time from individual sensors 50, 52, 54 and 56 of the vehicle, for example, a compressor rpm sensor 50, an outside air temperature sensor 52, an outdoor heat exchanger air flow rate sensor 54, and a recirculated inside air temperature sensor 56, the compressor RPM information, outside air temperature information, through the use of a pre-stored calculation formula.

On the other hand, this calculation part 42 stores a calculation formula for calculating an optimal control value. The optimal control value is calculated as a refrigerant compression ratio (X) as represented by the following calculation formula (1):

$$refrigerant compression ratio ( X ) = A \times compressor rpm + B \times outside air temperature + C \times outdoor heat exchanger air flow rate + D \times recirculated inside air temperature \times E , \qquad ( 1 )$$

where A is a correction coefficient for compressor rpm, B is a correction coefficient for outside air temperature, C is a correction coefficient for outdoor heat exchanger air flow rate, D is a correction coefficient for recirculated inside air temperature, and E is an experimental value constant.

In this regard, A, B, C, and D are correction coefficients for the respective factors that cause a change in the refrigerant compression ratio, i.e., the compressor rpm, the outside air temperature, the outdoor heat exchanger air flow rate, and the recirculated inside air temperature. The correction coefficients A, B, C, and D are pre-stored in the control part 20 and determined based on the results of several tests.

The correction coefficient A for the compressor rpm is a coefficient for correcting an error in the calculated value of the refrigerant compression ratio (X) due to the compressor rpm, and the correction coefficient B for the outside air temperature is a coefficient for correcting an error in the calculated value of the refrigerant compression ratio (X) due to the outside air temperature.

The correction coefficient C for the outdoor heat exchanger air flow rate is a coefficient for correcting an error in the calculated value of the refrigerant compression ratio (X) due to the outdoor heat exchanger air flow rate, and the correction coefficient D for the recirculated inside air temperature is a coefficient for correcting an error in the calculated value of the refrigerant compression ratio (X) due to the recirculated inside air temperature.

The correction coefficients A, B, C, and D are data obtained by considering the correlation between the compressor rpm and the refrigerant compression ratio, the correlation between the outside air temperature and the refrigerant compression ratio, the correlation between the outdoor heat exchanger air flow rate and the refrigerant compression ratio, and the correlation between the recirculated inside air temperature and the refrigerant compression ratio.

The experimental value constant E is used to correct the errors generated in the process of arithmetically processing the refrigerant compression ratio changing factors, i.e., the compressor rpm, the outside air temperature, the outdoor heat exchanger air flow rate, and the recirculated inside air temperature, through the use of the calculation formula (1). The experimental value constant E is pre-stored in the control part 40 and determined based on the results of several tests.

The calculation formula (1) is used to calculate the refrigerant compression ratio (X) by considering all of the various factors affecting the refrigerant compression ratio (X) and the correction coefficients and constant values for the respective factors. The refrigerant compression ratio (X) can be accurately calculated by using the calculation formula (1).

The refrigerant compression ratio (X) thus calculated is an optimal control value for controlling the heat pump mode expansion valve 12c.

Referring again to FIG. 2, in the heat pump mode, the control part 40 controls the opening degree of the heat pump mode expansion valve 12c based on the refrigerant compression ratio (X), which is the optimal control value of the heat pump mode expansion valve 12c calculated by the calculation part 42.

In particular, the control part 40 compares the optimal refrigerant compression ratio (X) calculated by the calculation part 42 with the current refrigerant compression ratio calculated through the use of detection data of the respective PT sensors 30 installed in the refrigerant circulation line 12, and precisely controls the opening degree of the heat pump mode expansion valve 12c according to the result of comparison.

More specifically, when the optimal refrigerant compression ratio (X) is calculated by the calculation part 42, the control part 40 compares the optimal refrigerant compression ratio (X) with the current refrigerant compression ratio calculated through the use of detection data of the respective PT sensors 30 installed in the refrigerant circulation line 12, and determines whether the following first condition is satisfied: [first condition]: optimal refrigerant compression ratio (X)>current refrigerant compression ratio (K)+preset compression ratio (a).

That is, the control part 40 determines whether the optimal refrigerant compression ratio (X) exceeds a compression ratio value obtained by adding a preset compression ratio (a) to the current refrigerant compression ratio (K).

As a result of the determination, if the first condition is satisfied, the control part 40 recognizes that the heating performance of the high pressure side heat exchanger 12b is insufficient at the present time, and increases the opening degree of the heat pump mode expansion valve 12c by a preset value.

Thus, the heat generation performance of the high pressure side heat exchanger 12b is improved, and the heating performance in the vehicle interior is enhanced.

On the other hand, as a result of the determination, if the first condition is not satisfied, the control part 40 determines whether the optimal refrigerant compression ratio (X) is less than a compression ratio value obtained by subtracting a preset compression ratio (a) from the current refrigerant compression ratio (K) as represented by a [second condition]: optimal refrigerant compression ratio (X)<current refrigerant compression ratio (K)−preset compression ratio (a).

As a result of the determination, if the second condition is satisfied, the control part 40 recognizes that the heating performance of the high pressure side heat exchanger 12b is excessive at the present time, and reduces the opening degree of the heat pump mode expansion valve 12c by a preset value. This reduces the heat generation performance of the high pressure side heat exchanger 12b.

Meanwhile, as a result of the determination, if the second condition is not satisfied, the control part 40 maintains the opening degree of the heat pump mode expansion valve 12c in the current state.

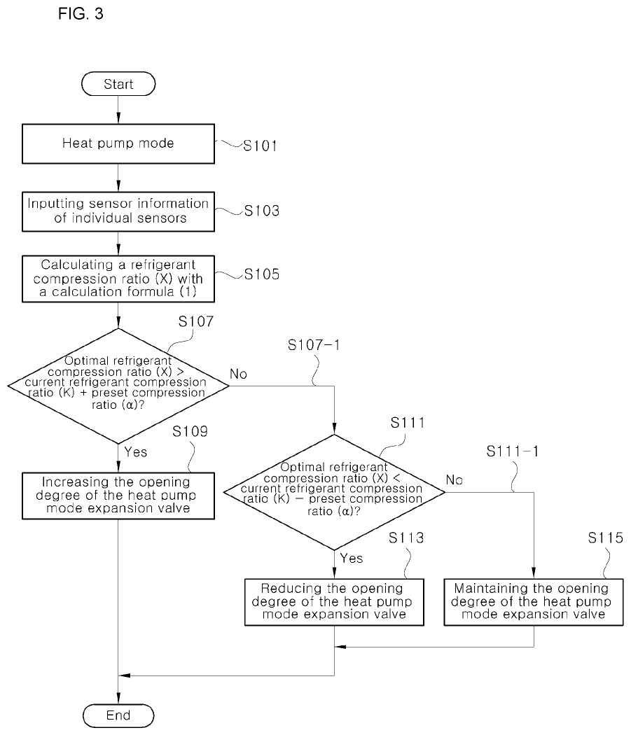

Next, an operation example of the vehicular heat management system according to the first embodiment of the present invention having such a configuration will be described in detail with reference to FIGS. 2 and 3.

Referring first to FIG. 3, in the heat pump mode (S101), various types of detection information are inputted from the sensors 50, 52, 54, and 56 (S103). For example, the compressor rpm information, the outside air temperature information, the outdoor heat exchanger air flow rate information, and the recirculated air temperature information are inputted.

When various types of detection information are inputted, the control part 40 calculates a refrigerant compression ratio (X) by arithmetically processing the inputted various types of detection information, the pre-stored correction coefficients and constants through the use of the above-described calculation formula (1) (S105).

When the calculation of the refrigerant compression ratio (X) is completed, the control part 40 compares the calculated optimal refrigerant compression ratio (X) with the current refrigerant compression ratio (K) calculated based on the detection data of the respective PT sensors 30 on the refrigerant circulation line 12, and determines whether the first condition is satisfied (S107).

That is, the control part 40 determines whether the optimal refrigerant compression ratio (X) exceeds a compression ratio value obtained by adding a preset compression ratio (a) to the current refrigerant compression ratio (K).

As a result of the determination, if the first condition is satisfied, the controller 40 increases the opening degree of the heat pump mode expansion valve 12c by a preset value (S109).

Then, the heat generation performance of the high pressure side heat exchanger 12b is enhanced, and the heating performance in the vehicle interior is improved.

On the other hand, as a result of the determination in step S107, if the first condition is not satisfied (S107-1), the control part 40 determines whether the second condition is satisfied (S111).

That is, the control part 40 determines whether the optimal refrigerant compression ratio (X) is less than a compression ratio value obtained by subtracting a preset compression ratio (a) from the current refrigerant compression ratio (K).

As a result of the determination, if the second condition is satisfied, the control part 40 reduces the opening degree of the heat pump mode expansion valve 12c by a preset value (S113). Then, the heat generation performance of the high pressure side heat exchanger 12b is reduced.

On the other hand, as a result of the determination in step S111, if the second condition is not satisfied (S111-1), the control part 40 maintains the opening degree of the heat pump mode expansion valve 12c in the current state (S115).

According to the vehicular heat management system of the first embodiment of the present invention, when the opening degree of the heat pump mode expansion valve 12c is controlled based on the optimal refrigerant compression ratio (X) calculated through the calculation formula (1), it is possible to optimally control the opening degree of the heat pump mode expansion valve.

In particular, it is possible to optimally control the opening degree of the heat pump mode expansion valve 12c regardless of the overheating degree of the refrigerant on the outlet side of the outdoor heat exchanger 12d.

As a result, it is possible to prevent a decrease in control precision of the heat pump mode expansion valve 12c caused by the control based on the overheating degree of the refrigerant on the outlet side of the outdoor heat exchanger 12d and a resultant decrease in heating performance for the vehicle interior.

In addition, since the optimal control value (optimal refrigerant compression ratio) for the heat pump mode expansion valve 12c is calculated based on all factors affecting the refrigerant compression ratio (X), a small change in the opening degree of the heat pump mode expansion valve 12c can be precisely reflected in the control of the heat pump mode expansion valve 12c.

In addition, since the small change in the opening degree of the heat pump mode expansion valve 12c can be precisely reflected in the control of the heat pump mode expansion valve 12c, it is possible to improve the control precision, sensitivity, and responsiveness of the heat pump mode expansion valve 12c.

In addition, since the control precision, sensitivity, and responsiveness of the heat pump mode expansion valve 12c can be improved, it is possible to improve the heating performance in the vehicle interior.

### Second Embodiment

In the second embodiment of the present invention, as shown in FIG. 2, the control part 40 calculates an optimal control value for controlling the heat pump mode expansion valve 12c as a refrigerant overcooling degree (Y) as represented by the following calculation formula (2):

$$refrigerant overcooling degree ( Y ) = a \times compressor rpm + b \times outside air temperature + c \times outdoor heat exchanger air flow rate + d \times recirculated inside air temperature \times e , \qquad ( 2 )$$

where a is a correction coefficient for compressor rpm, b is a correction coefficient for outside air temperature, c is a correction coefficient for outdoor heat exchanger air flow rate, d is a correction coefficient for recirculated inside air temperature, and e is an experimental value constant.

In this regard, a, b, c, and d are correction coefficients for the respective factors that cause a change in the refrigerant overcooling degree, i.e., the compressor rpm, the outside air temperature, the outdoor heat exchanger air flow rate, and the recirculated inside air temperature. The correction coefficients a, b, c, and d are pre-stored in the control part 20 and determined based on the results of several tests.

The correction coefficient a for the compressor rpm is a coefficient for correcting an error in the calculated value of the refrigerant overcooling degree (Y) due to the compressor rpm, and the correction coefficient b for the outside air temperature is a coefficient for correcting an error in the calculated value of the refrigerant overcooling degree (Y) due to the outside air temperature.

The correction coefficient c for the outdoor heat exchanger air flow rate is a coefficient for correcting an error in the calculated value of the refrigerant overcooling degree (Y) due to the outdoor heat exchanger air flow rate, and the correction coefficient d for the recirculated inside air temperature is a coefficient for correcting an error in the calculated value of the refrigerant overcooling degree (Y) due to the recirculated inside air temperature.

The correction coefficients a, b, c, and d are data obtained by considering the correlation between the compressor rpm and the refrigerant overcooling degree, the correlation between the outside air temperature and the refrigerant overcooling degree, the correlation between the outdoor heat exchanger air flow rate and the refrigerant overcooling degree, and the correlation between the recirculated inside air temperature and the refrigerant overcooling degree.

The experimental value constant e is used to correct the errors generated in the process of arithmetically processing the refrigerant overcooling degree changing factors, i.e., the compressor rpm, the outside air temperature, the outdoor heat exchanger air flow rate, and the recirculated inside air temperature, through the use of the calculation formula (2). The experimental value constant e is pre-stored in the control part 40 and determined based on the results of several tests.

The calculation formula (2) is used to calculate the refrigerant overcooling degree (Y) by considering all of the various factors affecting the refrigerant overcooling degree (Y) and the correction coefficients and constant values for the respective factors. The refrigerant overcooling degree (Y) can be accurately calculated by using the calculation formula (2).

The refrigerant overcooling degree (Y) thus calculated is an optimal control value for controlling the heat pump mode expansion valve 12c.

Referring again to FIG. 2, in the heat pump mode, the control part 40 controls the opening degree of the heat pump mode expansion valve 12c based on the refrigerant overcooling degree (Y), which is the optimal control value of the heat pump mode expansion valve 12c calculated by the calculation part 42.

In particular, the control part 40 compares the optimal refrigerant overcooling degree (Y) calculated by the calculation part 42 with the current refrigerant overcooling degree calculated through the use of detection data of the respective PT sensors 30 installed in the refrigerant circulation line 12, and precisely controls the opening degree of the heat pump mode expansion valve 12c according to the result of comparison.

More specifically, when the optimal refrigerant overcooling degree (Y) is calculated by the calculation part 42, the control part 40 compares the optimal refrigerant overcooling degree (Y) with the current refrigerant overcooling degree (L) calculated through the use of detection data of the respective PT sensors 30 installed in the refrigerant circulation line 12, and determines whether the following third condition is satisfied: [third condition]: optimal refrigerant overcooling degree (Y)>current refrigerant overcooling degree (L)+preset overcooling degree (B).

That is, the control part 40 determines whether the optimal refrigerant overcooling degree (Y) exceeds an overcooling degree value obtained by adding a preset overcooling degree (B) to the current refrigerant overcooling degree (L).

As a result of the determination, if the third condition is satisfied, the control part 40 recognizes that the heating performance of the high pressure side heat exchanger 12b is insufficient at the present time, and increases the opening degree of the heat pump mode expansion valve 12c by a preset value.

Thus, the heat generation performance of the high pressure side heat exchanger 12b is improved, and the heating performance in the vehicle interior is enhanced.

On the other hand, as a result of the determination, if the third condition is not satisfied, the control part 40 determines whether the optimal refrigerant overcooling degree (Y) is less than an overcooling degree value obtained by subtracting a preset overcooling degree (β) from the current refrigerant overcooling degree (L) as represented by a [fourth condition]: optimal refrigerant overcooling degree (Y)<current refrigerant overcooling degree (L)−preset overcooling degree (β).

As a result of the determination, if the fourth condition is satisfied, the control part 40 recognizes that the heating performance of the high pressure side heat exchanger 12b is excessive at the present time, and reduces the opening degree of the heat pump mode expansion valve 12c by a preset value. This reduces the heat generation performance of the high pressure side heat exchanger 12b.

Meanwhile, as a result of the determination, if the fourth condition is not satisfied, the control part 40 maintains the opening degree of the heat pump mode expansion valve 12c in the current state.

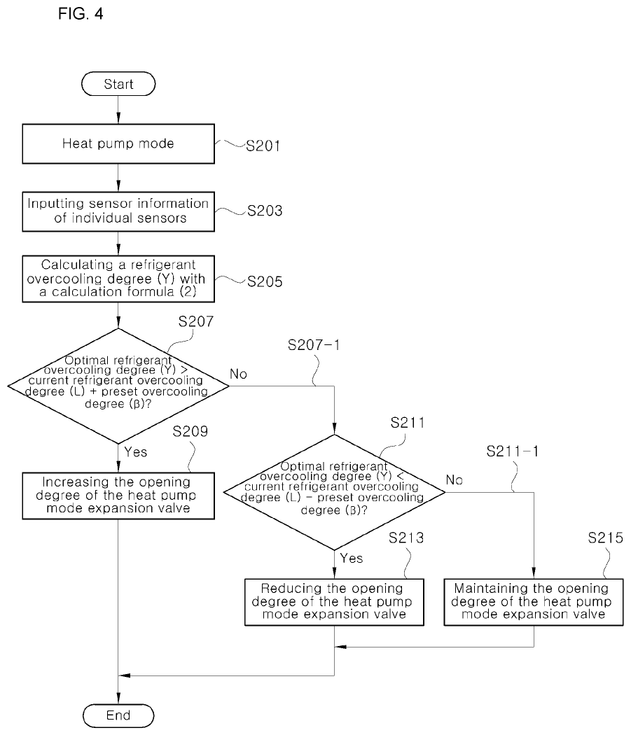

Next, an operation example of the vehicular heat management system according to the second embodiment of the present invention having such a configuration will be described in detail with reference to FIGS. 2 and 4.

Referring first to FIG. 4, in the heat pump mode (S201), various types of detection information are inputted from the sensors 50, 52, 54, and 56 (S203). For example, the compressor rpm information, the outside air temperature information, the outdoor heat exchanger air flow rate information, and the recirculated air temperature information are inputted.

When various types of detection information are inputted, the control part 40 calculates a refrigerant overcooling degree (Y) by arithmetically processing the inputted various types of detection information, the pre-stored correction coefficients and constants through the use of the above-described calculation formula (2) (S205).

When the calculation of the refrigerant overcooling degree (Y) is completed, the control part 40 compares the calculated optimal refrigerant overcooling degree (Y) with the current refrigerant overcooling degree (L) calculated based on the detection data of the respective PT sensors 30 on the refrigerant circulation line 12, and determines whether the third condition is satisfied (S207).

That is, the control part 40 determines whether the optimal refrigerant overcooling degree (Y) exceeds an overcooling degree value obtained by adding a preset overcooling degree (β) to the current refrigerant overcooling degree (L).

As a result of the determination, if the third condition is satisfied, the control part 40 increases the opening degree of the heat pump mode expansion valve 12c by a preset value (S209).

Then, the heat generation performance of the high pressure side heat exchanger 12b is enhanced, and the heating performance in the vehicle interior is improved.

On the other hand, as a result of the determination in step S207, if the third condition is not satisfied (S207-1), the control part 40 determines whether the fourth condition is satisfied (S211).

That is, the control part 40 determines whether the optimal refrigerant overcooling degree (Y) is less than an overcooling degree value obtained by subtracting a preset overcooling degree (B) from the current refrigerant overcooling degree (L).

As a result of the determination, if the third condition is satisfied, the control part 40 reduces the opening degree of the heat pump mode expansion valve 12c by a preset value (S213). Then, the heat generation performance of the high pressure side heat exchanger 12b is reduced.

On the other hand, as a result of the determination in step S211, if the third condition is not satisfied (S211-1), the control part 40 maintains the opening degree of the heat pump mode expansion valve 12c in the current state (S215).

According to the vehicular heat management system of the second embodiment of the present invention, when the opening degree of the heat pump mode expansion valve 12c is controlled based on the optimal refrigerant overcooling degree (Y) calculated through the calculation formula (2), it is possible to optimally control the opening degree of the heat pump mode expansion valve.

In addition, since the optimal control value (optimal refrigerant overcooling degree) for the heat pump mode expansion valve 12c is calculated based on all factors affecting the refrigerant overcooling degree (Y), it is possible to improve the control precision, sensitivity, and responsiveness of the heat pump mode expansion valve 12c, thereby improving the heating performance in the vehicle interior.

### Third Embodiment

In the third embodiment of the present invention, as shown in FIG. 2, the control part 40 is configured to control the compressor 12a of the refrigerant circulation line 12.

When the control part 40 controls the heat pump mode expansion valve 12c according to the optimal control value calculated using the calculation formula (1) or the calculation formula (2), for example, the refrigerant compression ratio (X) or the refrigerant overcooling degree (Y), the discharge air temperature of the air discharged into the vehicle interior is changed, and the target discharge temperature is also changed in real time according to the change in the discharge air temperature.

Accordingly, in the third embodiment of the present invention, the control part 40 is configured to variably control the rotational speed of the compressor 12a in response to changes in the target discharge temperature and the discharge air temperature.

More specifically, when the discharge air temperature in the vehicle interior and the target discharge temperature are changed in real time in the process of variably controlling the opening degree of the heat pump mode expansion valve 12c, the control part 40 compares the discharge air temperature in the vehicle interior with the target discharge temperature, and controls the rotational speed (rpm) of the compressor 12a according to the result of comparison.

In particular, the control part 40 compares the discharge air temperature in the vehicle interior with the target discharge temperature to determine whether the following fifth condition is satisfied: [fifth condition]: target discharge temperature (T1)>discharge air temperature (T2)+preset temperature (Y).

That is, the control part 40 determines whether the target discharge temperature (T1) exceeds a temperature value obtained by adding a preset temperature (Y) to the discharge air temperature (T2).

As a result of the determination, if the fifth condition is satisfied, the control part 40 recognizes that the heating performance of the high pressure side heat exchanger 12b is insufficient at the present time, and increases the rotational speed of the compressor 12a by a preset value.

Thus, the heat generation performance of the high pressure side heat exchanger 12b is improved, and the heating performance in the vehicle interior is enhanced.

On the other hand, as a result of the determination, if the fifth condition is not satisfied, the control part 40 determines whether the target discharge temperature (T1) is less than a temperature value obtained by subtracting a preset temperature (γ) from the discharge air temperature (T2) as represented by a [sixth condition]: target discharge temperature (T1)<discharge air temperature (T2)−preset temperature (γ).

As a result of the determination, if the sixth condition is satisfied, the control part 40 recognizes that the heating performance of the high pressure side heat exchanger 12b is excessive at the present time, and reduces the rotational speed of the compressor 12a by a preset value. This reduces the heat generation performance of the high pressure side heat exchanger 12b.

On the other hand, as a result of the determination, if the sixth condition is not satisfied, the control part 40 maintains the rotational speed of the compressor 12a in the current state.

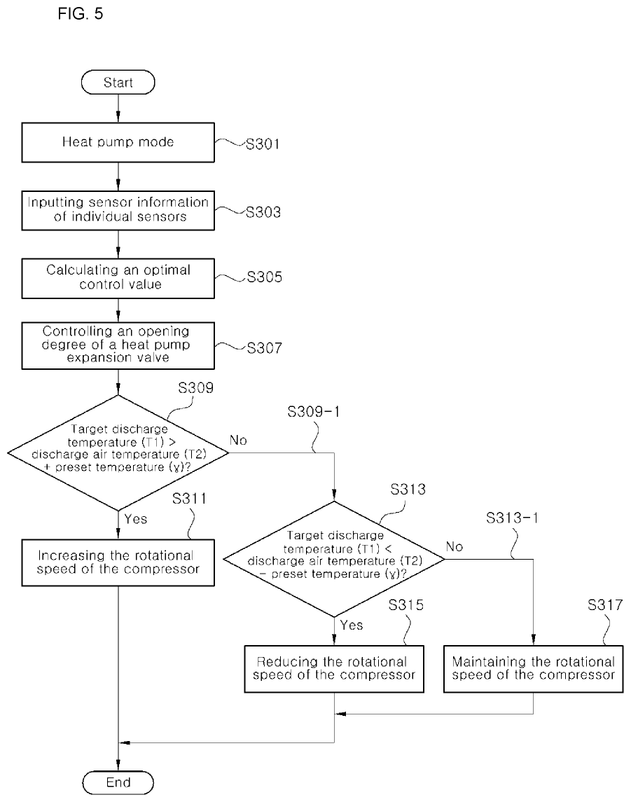

Next, an operation example of the vehicular heat management system according to the third embodiment of the present invention having such a configuration will be described in detail with reference to FIGS. 2 and 5.

Referring first to FIG. 5, in the heat pump mode (S301), various types of detection information are inputted from the sensors 50, 52, 54, and 56 (S303). For example, the compressor rpm information, the outside air temperature information, the outdoor heat exchanger air flow rate information, and the recirculated air temperature information are inputted.

When various types of detection information are inputted, the control part 40 calculates an optimal control value by arithmetically processing the inputted various types of detection information through the use of the pre-stored calculation formula (S305).

When the calculation of the optimal control value is completed, the control part 40 variably controls the opening degree of the heat pump mode expansion valve 12c with the calculated optimal control value (S307).

Meanwhile, in the process of variably controlling the opening degree of the heat pump mode expansion valve 12c, the control part 40 compares the target discharge temperature (T1) calculated in advance by processing various types of detection information with the current discharge air temperature (T2) in the vehicle interior detected by the vehicle interior discharge air temperature sensor 58 (see FIG. 2), and determines whether the fifth condition is satisfied (S309).

That is, the control part 40 determines whether the target discharge temperature (T1) exceeds a temperature value obtained by adding a preset temperature (Y) to the discharge air temperature (T2).

As a result of the determination, if the fifth condition is satisfied, the control part 40 increases the rotational speed of the compressor 12a by a preset value (S311).

Then, the heat generation performance of the high pressure side heat exchanger 12b is enhanced, and the heating performance in the vehicle interior is improved.

On the other hand, as a result of the determination in step S309, if the fifth condition is not satisfied (S309-1), the control part 40 determines whether the sixth condition is satisfied (S313).

That is, the control part 40 determines whether the target discharge temperature (T1) less than a temperature value obtained by subtracting a preset temperature (γ) from the discharge air temperature (T2).

As a result of the determination, if the sixth condition is satisfied, the control part 40 reduces the rotational speed of the compressor 12a by a preset value (S315). Then, the heat generation performance of the high pressure side heat exchanger 12b is reduced.

On the other hand, as a result of the determination in step S313, if the sixth condition is not satisfied (S313-1), the control part 40 maintains the rotational speed of the compressor 12a in the current state (S317).

According to the vehicular heat management system of the third embodiment of the present invention, the rotational speed of the compressor 12a is actively and variably controlled in response to the discharge air temperature in the vehicle interior and the target discharge temperature, which are changed in the optimal control process of the heat pump mode expansion valve 12c. Therefore, it is possible to maximize the heat pump mode operation efficiency of the air conditioning system.

In addition, since the heat pump mode operation efficiency of the air conditioning system can be maximized, it is possible to enhance the fuel efficiency of the vehicle and improve the heating performance in the vehicle interior.

While the preferred embodiments of the present invention have been described above, the present invention is not limited to the above-described embodiments. Various modifications and changes may be made without departing from the scope and spirit of the present invention defined in the claims.

1. A vehicular heat management system, comprising:
a refrigerant circulation line including a compressor, a high pressure side heat exchanger, an outdoor heat exchanger, a plurality of expansion valves arranged on the heat pump type refrigerant circulation line, and a low pressure side heat exchanger; and
a control part configured to calculate an optimal control value by arithmetically processing real-time information on one or more factors affecting a temperature and a pressure of a refrigerant circulating along the refrigerant circulation line, through the use of a pre-stored calculation formula, and control at least one of the expansion valves based on the calculated optimal control value.

2. The system of claim 1, wherein the factors affecting the temperature and the pressure of the refrigerant include a compressor rotational speed (rpm), an outside air temperature, an outdoor heat exchanger air flow rate, and a recirculated inside air temperature, and
the control part is configured to calculate the optimal control value by arithmetically processing information on the compressor rpm, the outside air temperature, the outdoor heat exchanger air flow rate, and the recirculated inside air temperature, through the use of the pre-stored calculation formula, and control at least one of the expansion valves based on the calculated optimal control value.

3. The system of claim 2, wherein the expansion valves include a heat pump mode expansion valve configured to depressurize and expand a refrigerant flowing from the high pressure side heat exchanger to the outdoor heat exchanger in a heat pump mode, and
the control part is configured to control an opening degree of the heat pump mode expansion valve based on the calculated optimal control value in the heat pump mode.

4. The system of claim 3, wherein the control part is configured to calculate an optimal control value for the heat pump mode expansion valve as a refrigerant compression ratio (X) by arithmetically processing the information on the compressor rpm, the outside air temperature, the outdoor heat exchanger air flow rate, and the recirculated inside air temperature, which are inputted in real time from individual sensors, through the use of the following calculation formula (1):
$$refrigerant compression ratio ( X ) = A \times compressor rpm + B \times outside air temperature + C \times outdoor heat exchanger air flow rate + D \times recirculated inside air temperature \times E , \qquad ( 1 )$$
where A is a correction coefficient for compressor rpm, B is a correction coefficient for outside air temperature, C is a correction coefficient for outdoor heat exchanger air flow rate, D is a correction coefficient for recirculated inside air temperature, and E is an experimental value constant.

5. The system of claim 4, wherein the control part is configured to compare the refrigerant compression ratio (X) calculated through the use of the calculation formula (1) with a current refrigerant compression ratio (K) calculated through the use of detection data of individual PT sensors on the refrigerant circulation line, and variably control the opening degree of the heat pump mode expansion valve based on the result of comparison.

6. The system of claim 5, wherein the control part is configured to compare the optimal refrigerant compression ratio (X) calculated through the use of the calculation formula (1) with the current refrigerant compression ratio (K) to determine whether the following first condition is satisfied: [first condition]: optimal refrigerant compression ratio (X)>current refrigerant compression ratio (K)+preset compression ratio (α), and
if the first condition is satisfied, the control part increases the opening degree of the heat pump mode expansion valve by a preset value.

7. The system of claim 6, wherein the control part is configured to compare the optimal refrigerant compression ratio (X) calculated through the use of the calculation formula (1) with the current refrigerant compression ratio (K) to determine whether the following second condition is satisfied: [second condition]: optimal refrigerant compression ratio (X)<current refrigerant compression ratio (K)−preset compression ratio (α), and
if the second condition is satisfied, the control part reduces the opening degree of the heat pump mode expansion valve by a preset value.

8. The system of claim 7, wherein if the first condition and the second condition are not satisfied, the control part maintains the opening degree of the heat pump mode expansion valve in a current state.

9. The system of claim 3, wherein the control part is configured to calculate an optimal control value for the heat pump mode expansion valve as a refrigerant overcooling degree (Y) by arithmetically processing the information on the compressor rpm, the outside air temperature, the outdoor heat exchanger air flow rate, and the recirculated inside air temperature, which are inputted in real time from individual sensors, through the use of the following calculation formula (2):
$$refrigerant overcooling degree ( Y ) = a \times compressor rpm + b \times outside air temperature + c \times outdoor heat exchanger air flow rate + d \times recirculated inside air temperature \times e , \qquad ( 2 )$$
where a is a correction coefficient for compressor rpm, b is a correction coefficient for outside air temperature, c is a correction coefficient for outdoor heat exchanger air flow rate, d is a correction coefficient for recirculated inside air temperature, and e is an experimental value constant.

10. The system of claim 9, wherein the control part is configured to compare the optimal refrigerant overcooling degree (Y) calculated through the use of the calculation formula (2) with a current refrigerant overcooling degree (L) calculated through the use of detection data of individual PT sensors on the refrigerant circulation line, and variably control the opening degree of the heat pump mode expansion valve based on the result of comparison.

11. The system of claim 10, wherein the control part is configured to compare the optimal refrigerant overcooling degree (Y) calculated through the use of the calculation formula (2) with the current refrigerant overcooling degree (L) to determine whether the following third condition is satisfied: [third condition]: optimal refrigerant overcooling degree (Y)>current refrigerant overcooling degree (L)+preset overcooling degree (β), and
if the third condition is satisfied, the control part increases the opening degree of the heat pump mode expansion valve by a preset value.

12. The system of claim 11, wherein the control part is configured to compare the optimal refrigerant overcooling degree (Y) calculated through the use of the calculation formula (2) with the current refrigerant overcooling degree (L) to determine whether the following fourth condition is satisfied: [fourth condition]: optimal refrigerant overcooling degree (Y)<current refrigerant overcooling degree (L)−preset overcooling degree (β), and
if the fourth condition is satisfied, the control part reduces the opening degree of the heat pump mode expansion valve by a preset value.

13. The system of claim 12, wherein if the third condition and the fourth condition are not satisfied, the control part maintains the opening degree of the heat pump mode expansion valve in a current state.

14. The system of claim 1, wherein the control part is configured to variably control the rotational speed of the compressor according to a discharge air temperature in a vehicle interior changed in real time in a process of controlling the expansion valve and a target discharge temperature.

15. The system of claim 14, wherein when the current discharge air temperature in the vehicle interior and the target discharge temperature are changed in the process of controlling the expansion valve, the control part compares the current discharge air temperature in the vehicle interior with the target discharge temperature, and variably controls the rotational speed of the compressor based on the result of comparison.

16. The system of claim 15, wherein the control part compares the current discharge air temperature with the target discharge temperature to determine whether the following fifth condition is satisfied: [fifth condition]: target discharge temperature (T1)>discharge air temperature (T2)+preset temperature (γ), and if the fifth condition is satisfied, the control part increases the rotational speed of the compressor by a preset value.

17. The system of claim 16, wherein the control part compares the current discharge air temperature with the target discharge temperature to determine whether the following sixth condition is satisfied: [sixth condition]: target discharge temperature (T1)<discharge air temperature (T2)−preset temperature (γ), and if the sixth condition is satisfied, the control part reduces the rotational speed of the compressor by a preset value.

18. The system of claim 17, wherein if the fifth condition and the sixth condition are not satisfied, the control part maintains the rotational speed of the compressor in a current state.
